(19) United States
(12) Patent Application Publication
(10) Pub. No.: US 2005/0038888 A1
(43) Pub. Date: Feb. 17, 2005

(54) Method of and apparatus for monitoring event logs

(76) Inventor: Bernd Labertz, Gartringen (DE)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/697,641

(22) Filed: Oct. 31, 2003

(30) Foreign Application Priority Data
Aug. 11, 2003 (DE) 103 37 144.3

(51) Int. Cl. G06F 15/173; G06F 15/16

(52) U.S. Cl. 709/224; 709/217

(57) ABSTRACT

Plural local event logs of nodes of a computer network are monitored and then stored in a central database. The central database is transferred at customisable, periodic time intervals to a support computer system for analysis of the local event logs. If a potential problem is detected by the support computer system an alert message is generated automatically.

### FIELD OF THE INVENTION

The present invention relates generally to the field of data processing, and more particularly without limitation, to event log monitoring.

### BACKGROUND AND PRIOR ART

The process of recording events is referred to as “event logging”, a terminology adopted from the meticulous practice that a ship's captain uses to enter daily notes during a sea voyage. In the electronic world, events are logged in storage devices and later used to derive some desired information concerning usage and operation of the system.

Some computer operating systems have an event logging component. The Windows operating system from Microsoft Corporation logs events which reflect operation of the computer system. The events are logged locally to a storage, such as the hard disk drive, that is resident on the same computer that the operating system is running.

Typically event logs are checked by the system administrator after a problem or malfunction occurred in order to identify the cause of the problem. Such a manual checking procedure is a tedious task. Therefore various methods for automatic monitoring of event logs have been devised in the prior art:

U.S. Pat. No. 5,867,659 shows an event log forwarder which accesses a set of one or more filters and checks whether a new event in one or more event logs satisfies the set of one or more filters. The event log forwarder also provides an indication if there is a new event which satisfies the set of one or more filters. Additionally, the event log forwarder automatically repeats, at periodic intervals, checking whether a new event in one or more event logs satisfies the set of one or more filters and provides an indication if there is a new event which satisfies the set of one or filters.

U.S. Pat. No. 6,347,335 shows a common event log for a distributed computer system including a plurality of computer nodes. The common event log includes a plurality of storage locations for storing common event log entries. Each computer node performs processing operations in connection with a program, and generates, at selected points in its program, an event log entry including status information representing status of the computer node at the point at which the log entry was generated, the computer nodes storing the event log entries which they generate in the common event log contemporaneous with the generation thereof. As a result, the event log entries are stored in the common event log in the order in which the computer nodes reach the points in their respective programs. The common event log includes a buffer comprising a plurality of storage locations, and the location at which an entry is to be stored is pointed to by a write pointer.

U.S. Pat. No. 6,507,852 shows an location-independent service for monitoring and alerting on an event log. For monitoring of the event log one or more alert policies are accessed, wherein each of the alert policies is comprised of one or more rules stored on a computer. An event log stored on a computer is accessed in a location-independent manner to gather one or more event messages stored therein. The event messages are filtered by comparing them to the rules of the alert policies to raise an alert and determine whether an alert action should be invoked.

### SUMMARY OF THE INVENTION

The present invention provides for a method of monitoring a plurality of local event logs of a computer network. The local event logs are entered into a central database of the computer network. The central database is sent from the computer network to an external support computer system for analysis of the local event logs.

In accordance with a preferred embodiment of the invention the node identifiers of the network nodes are used as keys for storing of the local event logs in the central database. This enables the external support computer system to analyse the individual local event logs stored in the central database with respect to individual ones of the network nodes.

In accordance with a further preferred embodiment of the invention the central database resides on a server computer of the computer network. The local event logs are transmitted from the network nodes to the server computer and are stored in the central database. Preferably the server computer has a local server event log which is also stored in the central database.

In accordance with a further preferred embodiment of the invention the transmission of the local event logs from the network nodes to the server computer is initiated by the server computer. This can be done by remote execution of program code which is provided from the server computer to the network nodes.

In accordance with a further preferred embodiment of the invention a discovery procedure is carried out prior to transmission of the local event logs to the server computer. In the discovery procedure the network topology, network node configurations and/or other data is determined by the server computer. The network topology information and configuration information can be utilized by the server computer to collect the local event logs from the network nodes.

In accordance with a further preferred embodiment of the invention the central database is sent from the server computer of the customer computer network to the external support computer system at periodic time intervals which are customisable. The external support computer system performs an analysis of the local event logs stored in the central database and generates an alert message if a potential problem is identified. Preferably the analysis is performed by means of a rule base of alert policies.

In accordance with a further preferred embodiment of the invention the external support computer system performs as database query in order to identify the last “send event” which has been entered into the local server event log. The “send event” indicates when a previous transfer of the central database to the external support computer system occurred.

The time stamp of the “send event” is used by the external support computer system to perform another database query in order to identify those local event log entries having time stamps after the “send event” time stamp. In other words the external support computer system determines those local event log entries which are new, i.e. which have not been included in a central database which has been received previously. This way it is prevented that alert messages are generated for past events which had already been analysed in a previous event log analysis.

In accordance with a further preferred embodiment of the invention the external support computer system generates an alert message for a response center engineer and sends the alert message as an email to an email address of the response center engineer if an alert condition is detected.

In accordance with a further preferred embodiment of the invention the external support computer system is used as a response center for servicing a plurality of customer computer networks. The response center computer receives central databases containing local event logs from the various customer computer networks for event log analysis.

### BRIEF DESCRIPTION OF THE DRAWINGS

In the following preferred embodiments of the invention will be described, by way of example, and with reference to the drawings in which:

FIGS. 1a and 1b, together, is a block diagram of a computer network having a server computer for storing of local event logs in a central database,

FIG. 2 is a block diagram of a support computer system for analysis of local event logs stored in the central database,

FIGS. 3a and 3b, together, is illustrative of a flowchart of a preferred embodiment of a method of the invention,

FIG. 4 is illustrative of local event logs stored in a central database.

### DETAILED DESCRIPTION

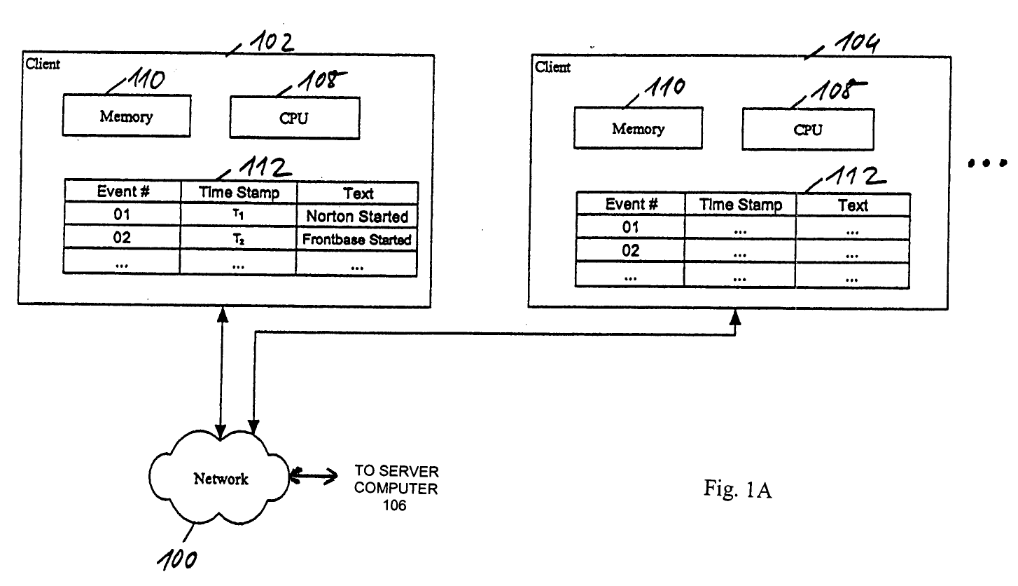

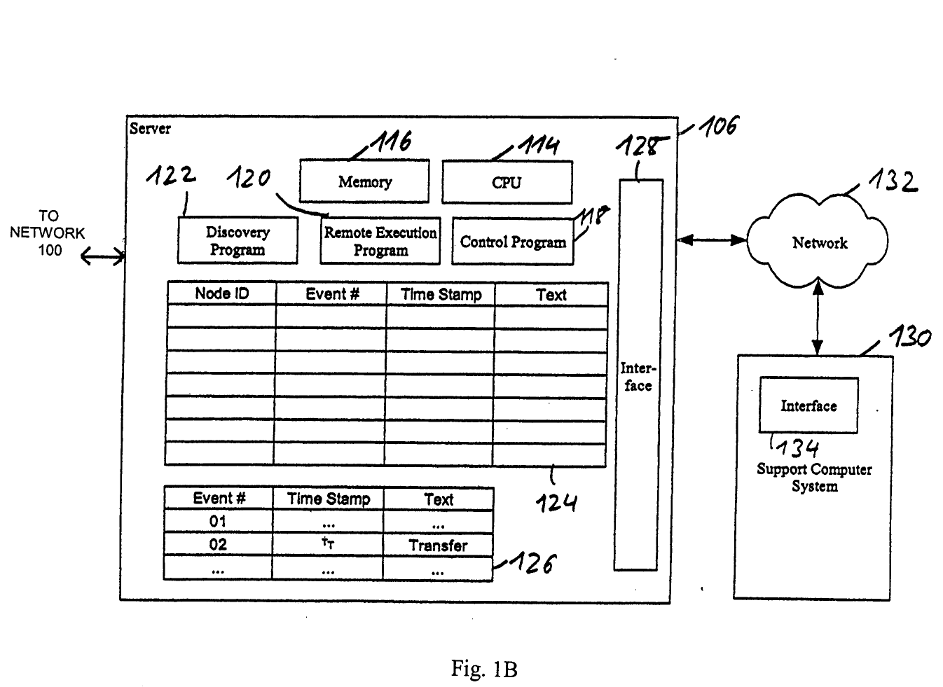

FIGS. 1a and 1b show a computer network 100. Computer network 100 has various network nodes including client computers 102, 104, . . . and server computer 106. For example computer network 100 is a local area network (LAN).

Client computer 102 has central processing unit (CPU) 108 and memory 110. For example client computer 102 uses a Windows operating system which generates local event log 112; local event log 112 is stored locally on client computer 102. Events like starting, finishing or manually stopping an application program or execution of other actions are stored in local event log 112. Each entry into local event log 112 has a text string being descriptive of an event and an event identification number. Further each entry in local event log 112 is time stamped when it is entered in local event log 112.

In the example considered here an event has been entered into local event log 112 when the Norton AntiVirus application program has been started. Event identification number 01 is assigned to this event and a corresponding entry is made into local event log 112 by the operating system. This entry is time stamped with time T₁ on which the event occurred.

Likewise an entry into local event log 112 is made when the Frontbase Database program started at time T₂. Subsequently a number of other events is entered into local event log 112.

Depending on the customizing settings of the Windows operating system past events which are likely of not being of interest to the network administrator anymore are automatically erased from the local event log 112 in order to limit the size of local event log 112. This can be done by using a predefined time window to remove old event log entries.

The other client computers 104, . . . of network 100 have a similar design.

Server computer 106 has CPU 114 and memory 116. Further server computer 106 has control program 118, remote execution program 120 and discovery program 122.

Control program 118 can start discovery program 122 in order to initiate a discovery procedure for the network nodes of network 100 and it can initiate the transfer of the local event logs 112 from the client computers 102, 104, . . . to the server computer 106 for storage in central database 124.

Preferably server computer 106 also runs a Windows operating system which creates local server event log 126.

Server computer 106 has interface 128 for sending of central database 124 to support computer system 130 over network 132. Support computer system 130 has a corresponding interface 134 for receiving of central database 124 from server computer 106 over network 132. For example network 132 is the Internet and the interfaces 128 and 134 are adapted for communication over the Internet.

In operation an entry is created in local server event log 126 each time a transfer of central database 124 to support computer system 130 occurs. The corresponding entry is made into local server event log 126 after central database 124 has been sent out from server computer 106. In the example considered here a previous transfer of central database 124 occurred at time T_{T} which was entered as event entry # 02 in local server event log 126.

Control program 118 periodically starts discovery program 122 for discovery of the network nodes of computer network 100, including client computers 102, 104, . . . After completion of the discovery procedure control program 118 initiates the transmission of the local event logs 112 from the client computers 102, 104, . . . to server computer 106 over network 100 by transmitting of remote execution program 120 to clients 102, 104, . . .

When remote execution program 120 is remotely executed on clients 102, 104, . . . by server computer 106 the event logs 112 stored on client computers 102, 104, . . . are transmitted over network 100 to server computer 106 and stored in central database 124. The respective node IDs of client computers 102, 104, . . . are used as keys for storing of the respective event log entries. Further, local server event log 126 is also stored in central database 124.

Next control program 118 sends central database 124 to support computer system 130 over network 132. After completion of this “send event” a corresponding entry is made in local server event log 126 with a time stamp indicating when central database 124 was sent out. This procedure is repeated at customisable periodic time intervals.

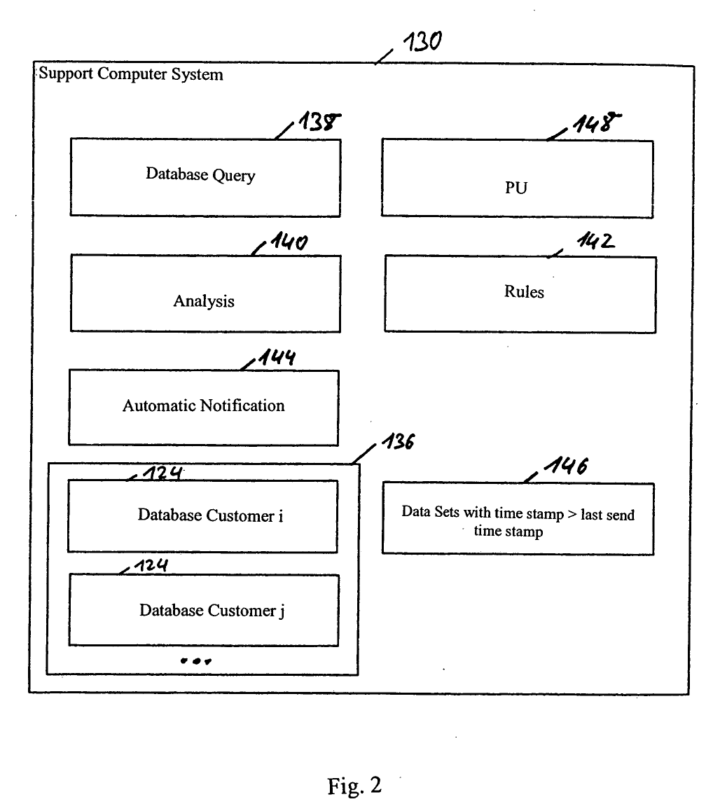

FIG. 2 shows a more detailed block diagram of support computer system 130. Support computer system 130 has storage 136 for storing central databases of the type of central database 124 as shown in FIG. 1. Typically support computer system 130 provides network support services for a plurality of customers i, j, . . . Storage 136 has sufficient capacity for storing of a plurality of central databases 124 received from the various customer computer networks of the type of computer network 100 as depicted in FIG. 1.

Further support computer system 130 has database query program 138, event log analysis program 140 for performing an analysis of the event logs stored in one of central databases 124 in accordance with rules stored in rule base 142, automatic notification program 144 for sending out a message to a response center engineer in case an alert situation is detected, and memory 146 for storing of data sets to be analysed by event log analysis program 140.

In operation support computer system 130 receives a sequence of central databases 124 from various customers i, j, . . . These central databases 124 are stored in storage 136. Preferably the central databases 124 are processed sequentially in the order of arrival; alternatively the central databases 124 are processed in parallel if processing unit (PU) 148 of computer system 130 has parallel processing capabilities.

For processing of central database 124 received from server computer 106 (cf. FIG. 1) of customer i database query program 138 is started in order to retrieve a “send entry” from central database 124 with the latest time stamp. This time stamp indicates the point of time when a previous sent action of central database 124 had been performed by server computer 106.

Next database query program 138 queries central database 124 received from customer i in order to identify those data sets having a time stamp later than the previous “send entry” time. These data sets are stored in memory 146 for analysis by event log analysis program 140.

The advantage of determining the previous “send entry” time is that this way those data sets which have been entered after the previous send action are identified. This prevents that the same data sets are analysed each time a new copy of central database 124 is received from customer i.

The data sets which are stored in memory 146 are analysed by event log analysis program 140 in accordance with rules stored in rule base 142. These rules reflect corresponding alert policies for identification of a potential problem of computer network 100 (cf. FIG. 1) of customer i. If such a potential problem is detected automatic notification program 144 is invoked in order to send a corresponding message to a response center engineer.

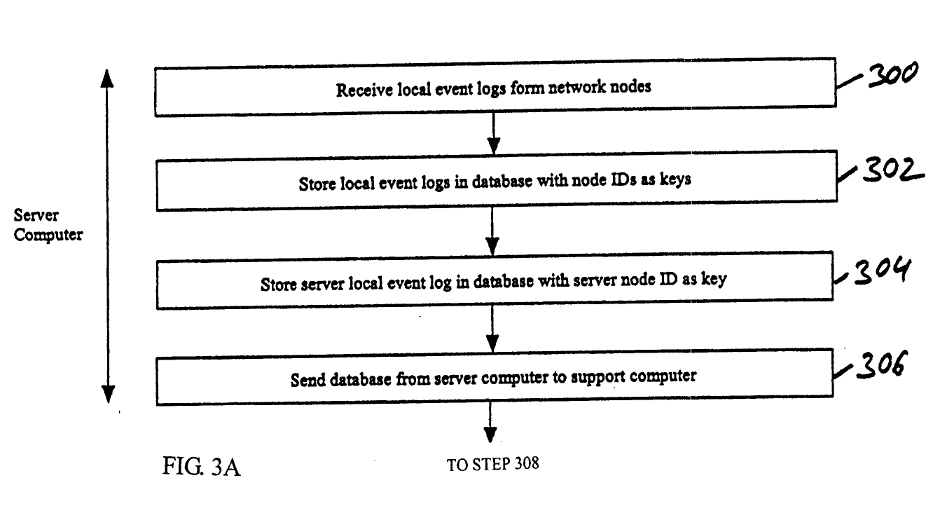

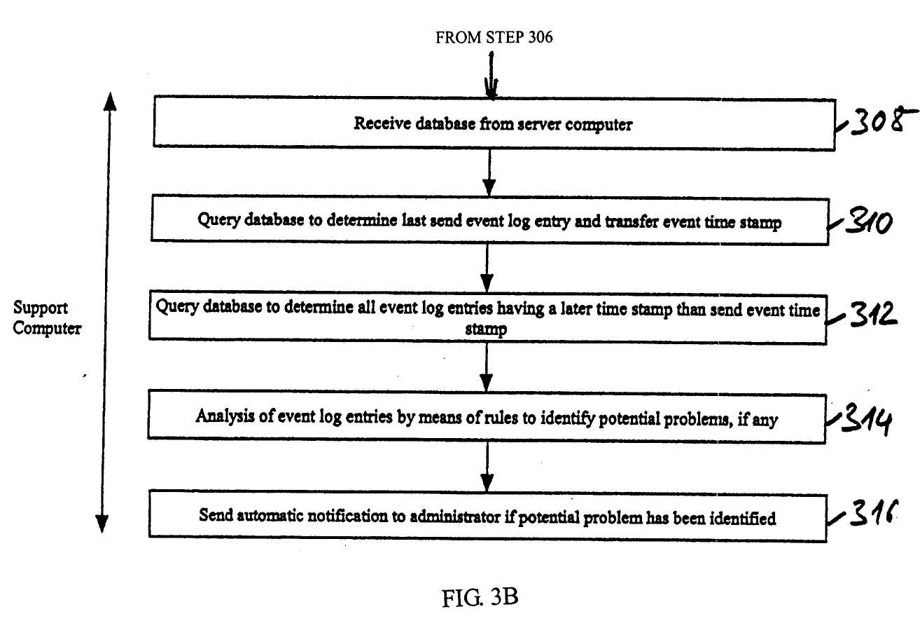

FIGS. 3a and 3b, together, show a corresponding flowchart. In step 300 local event logs are received by a server computer of a customer computer network. The local event logs which are received from the network nodes are stored in a database using the node identifiers (ID) of the network nodes as respective keys. This is done in step 302.

In step 304 the local event log of the server computer is also stored in the database using the node ID of the server computer as a key. Next the database is sent from the server computer to an external support computer in step 306. Preferably steps 300 to 306 are initiated by the server computer at customisable periodic intervals.

In step 308 the database is received by the external support computer. In step 310 a database query is performed by the support computer in order to identify a “send event” log entry which was entered for a send event of the database from the server computer to the external support computer prior to the transfer of step 306. The corresponding “send event” time stamp of the send event log entry is used in step 312 in order to carry out a database query for determination of all event log entries stored in the database which have a time stamp which is later than the “send event” time stamp. This way a differential set of event log entries is created. The differential set of event log entries comprises all event log entries which have been added to the central database 124 after the previous database transfer.

In step 314 the event log entries comprised in the differential set are analysed by means of rules which define a set of alert policies. This way potential problems are identified. If such a potential problem is identified an automatic notification is sent to an administrator or response center engineer. Preferably a corresponding email message containing a description of the identified potential problem and/or of the corresponding event log entries is generated and sent automatically to the response center engineer. The response center engineer can then contact the corresponding customer to which the identified potential problem relates for corrective action.

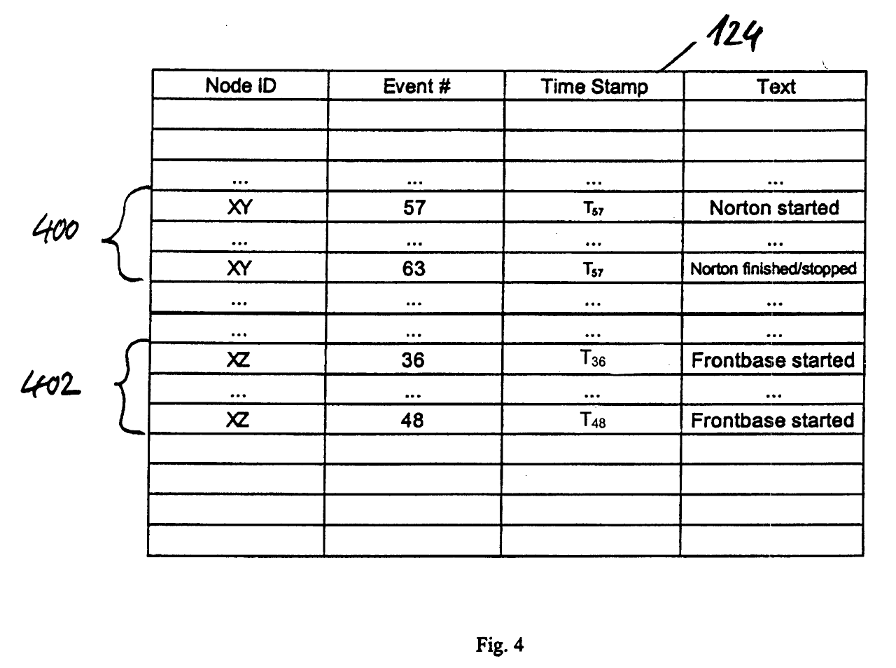

FIG. 4 shows a set 400 of event log entries of a network node XY. When the Norton AntiVirus program was started on network node XY a corresponding event log entry is generated and stored in the local event log of node XY. The event log ID is 57; when the event log ID was created it was time stamped at time T₅₇.

Further set 400 which is stored in central database 124 contains an event being descriptive of the termination of the Norton AntiVirus program by either finishing or manually stopping the Norton AntiVirus application program. The corresponding event is entered with event identifier 63 and time stamp T₆₃. Further set 400 contains other event log entries relating to other application programs. From set 400 it appears that with respect to the Norton AntiVirus application program no problem occurred as the Norton AntiVirus application program was normally started and terminated.

Set 402 stored in central database 124 contains a set of event log entries being related to network node XZ. Event with event identifier 36 was entered when the Frontbase Database program was started at time T₃₆. Event number 48 indicates that Frontbase Database was started again at time T₄₈. Between events 36 and 48 Frontbase Database was not terminated. This indicates that an abnormal situation may be present and an alert message is generated by the system.

### List of Reference Numerals

100 computer network
102 client computer
104 client computer
106 server computer
108 central processing unit
110 memory
112 local event log
114 central processing unit
116 memory
118 central program
120 remote execution program
122 discovery program
124 central database
126 local server event log
128 interface
130 support computer system
132 network
134 interface
136 storage
138 database query program
140 event log analysis program
142 rule base
144 automatic notification program
146 memory
148 processing unit
400 set
402 set

1. A method of monitoring a plurality of local event logs of a computer network, the method comprising:
entering the local event logs in a central database of the computer network, and
sending the central database from the computer network to an external support computer system for analysis of the local event logs.

2. The method of claim 1, wherein each local event log is generated for one particular node of the computer network, and storing the local event logs in—the central database using a corresponding node identifier as a key.

3. The method of claim 1, the computer network comprising a server computer for storing the central database, the server computer having a local server event log, the method further comprising storing the local server event log in the central database, and sending the central database from the server computer of the computer network to the external support computer system.

4. The method of claim 3, further comprising entering an event into the local server event log after the central database has been sent to the external support computer system.

5. The method of claim 1, wherein each event log entry in a local event log has an event identifier, a time stamp and event information descriptive of the event.

6. The method of claim 1, wherein the central database is stored on a server computer of the computer network, and further comprising the steps of:
coupling program code from the server computer to network nodes of the computer network, and
transferring the local event logs of the network nodes to the server computer by remotely executing the program code by the server computer on the network nodes.

7. A memory storing a computer program for causing a computer network to generate a central database for storing local event logs of network nodes of the computer network, the computer program causing the computer network to perform the steps of:
transmitting the respective local event logs from the network nodes to a server computer of the computer network,
storing the local event logs in the central database on the server computer using the node identifiers of the network nodes as keys for the respective local event logs, and
storing a local server event log of the server computer in the central database, the local server event log being adapted to store a send event after the central database has been sent to an external support computer system for analysis of the local event logs.

8. The memory of claim 7, wherein the program causes the network to send the central database to the external support computer system at customisable periodic time intervals.

9. The memory of claim 7, wherein the program includes program code for remote execution on the network nodes to cause the network nodes to send the respective local event logs to the server computer.

10. A server computer system of a computer network having a plurality of network nodes, the server computer system comprising:
a controller for causing the network nodes to transmit respective local event logs of the network nodes to the server computer system,
a store for the local event logs in a central database,
a transmitter for sending the central database to an external support computer system for analysis of the local event logs.

11. The server computer system of claim 10, further comprising a local server event log for storing an event in response to the central database being sent to the external support computer system, the send event having a time stamp.

12. A discovery server comprising:
a discovery program component for discovery of network nodes of a computer network,
a remote execution program component for causing the network nodes to transmit respective local event logs to the discovery server,
a central database for storing the local event logs and for storing a local discovery server event log, and
an interface component for sending the central database to the external support computer system for analysis of the local event logs.

13. The discovery server of claim 12, wherein the local discovery server event log is adapted to store an event indicative of a transfer of the central database from the discovery server to the external support computer system.

14. A method of monitoring a plurality of local event logs, the method comprising the steps of:
receiving a database from a customer computer network, the database comprising the local event logs of network nodes of the computer network,
querying the database to identify a database send event in the local event logs and its corresponding sent time stamp,
querying the database to identify local event log entries having time stamps later than the sent time stamp.

15. The method of claim 14, further comprising comparing the identified event log entries to rules of alert policies to determine whether an alert action should be invoked.

16. The method of claim 15, further comprising sending an email message to a response center engineer as an alert action.

17. A memory storing a computer program for enabling a computer to monitor plural local event logs of a computer network, the computer program causing the computer to perform the steps of:
storing a database associated with a customer computer network, the database comprising the local event logs of network nodes of the computer network,
querying the database to identify a database send event in the local event logs and its corresponding sent time stamp, and
querying the database to identify local event log entries having time stamps later than the sent time stamp.

18. The memory of claim 17, wherein the program causes the computer to determine whether an alert action should be invoked by comparing the identified event log entries to rules of alert policies.

19. The memory of claim 18, wherein the program causes the computer to send an automatic notification to a response center engineer if the determining step determines an alert action should be invoked.

20. The memory of claim 17, wherein the computer program causes the computer to receive from the customer computer network the database associated with the customer computer network.

21. A support computer system for providing network support services for a customer computer network, the support computer system comprising:
a memory for storing a database associated with the customer computer network, the database comprising local event logs of network nodes of the customer computer network,
a database query component for querying the database to determine a database send event and its corresponding transfer time stamp in the database and for querying the database to identify event log entries having time stamps later than the sent time stamp,
an analysis component for comparing the identified event log entries to the rules of alert policies to determine whether an alert action should be invoked.

22. A system according to claim 21 wherein the memory is adapted to re-ceive from the customer's computer network the database associated with the customer computer network.

23. A response center computer system for providing network support services for a plurality of customer computer networks, the response center computer system comprising:
a memory for storing a database associated with the customer computer network, the database comprising local event logs of network nodes of the customer computer network,
a database query component for querying the database to determine a database send event and its corresponding transfer time stamp in the database and for querying the database to identify event log entries having time stamps later than the sent time stamp,
an analysis component for comparing the identified event log entries with rules of alert policies to determine whether an alert action should be invoked, and
an automatic notification component for sending an email message to a response center engineer in response to the analysis component determining that an alert action should be invoked.

24. A system according to claim 23 wherein the memory is adapted to receive from the customer's computer network the database associated with the customer computer network.
